(19) United States
(12) Patent Application Publication
(10) Pub. No.: US 2009/0283228 A1
(43) Pub. Date: Nov. 19, 2009

(54) GUIDE

(75) Inventor: John HORSCH, New South Wales (AU)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB, SANDVIKEN (SE)

(21) Appl. No.: 12/467,713

(22) Filed: May 18, 2009

(30) Foreign Application Priority Data
May 19, 2008 (AU) 2008100459

(51) Int. Cl. E06B 7/00

(52) U.S. Cl. 160/370; 160/405

(57) ABSTRACT

A guide for aligning at least one mesh interstice of more than one respective mesh panel. The guide includes a first portion configured for engaging the first mesh panel and a second portion configured for engaging a further mesh panel is disclosed. When the first and second portions are engaged, the at least one mesh interstice of the respective first and further mesh panels are caused to substantially align.

### CROSS-REFERENCE TO RELATED APPLICATIONS

This application claims priority under 35 U.S.C. §119 to Australian Application No. 2008100459 filed in Australia on May 19, 2008; the entire contents of which are hereby incorporated by reference.

### FIELD

The present disclosure relates to a guide for aligning mesh panels and to a method of installing mesh panels. The disclosed guide and method have particular application for use in mining in strata control and is herein described in that context.

### BACKGROUND

For mining operations it is often necessary to install or affix panels of fabricated mesh along the interior surfaces of underground thoroughfares to secure and thus prevent rock and the debris from falling causing potential injury or fatality. When installing such mesh panels it is necessary to overlap adjacent panels for achieving the maximum possible coverage and often necessary to ensure a clear passage exists between overlapping mesh edges so fasteners may be applied without obstruction. This involves orientating and retaining the respective mesh panels in position while a fastener can be presented to secure same.

It is to be understood that, if any prior art publication(s) or use(s) are referred to herein, such references do not constitute an admission that the publication(s) or act(s) form a part of the common general knowledge in the art.

### SUMMARY

According to a first embodiment, there is provided a guide for aligning one mesh interstice of more than one respective mesh panel, the guide comprising: a first portion configured for engaging the first mesh panel; and a second portion configured for engaging a further mesh panel, wherein, when the first and second portions are so engaged, the at least one mesh interstice of the respective first and further mesh portions are caused to substantially align.

A guide is provided that is able to simplify the installation of mesh panels. The guide is configured to engage with overlapping mesh panel to cause interstices of those panels to align. This therefore provides a simple means to align the mesh panels.

The required engagement between the mesh panel and the guide to provide the aligning of the panels may be the same for both portions or may differ between portions. In one form, the required engagement is through clipping or otherwise securing a portion of the guide to the boundary structure of the panel interstice. In one embodiment, at least one of the first and second portions of the guide is configured for placement within a mesh interstice of a mesh panel to provide the required engagement.

In a particular embodiment, the guide includes a base and at least one generally cylindrical body, wherein the first and second portions are formed as sections on the body, or on a respective one of the bodies. In this arrangement, the or each body is caused to pass through the overlapping interstices of the mesh panels to effect the required engagement for alignment of the panels.

In one embodiment, at least one of the bodies further comprises first and second parts that are separated by an axial slit extending from a distal end of the body, the parts being able to resiliently flex towards one another so as to reduce the cross-sectional area of the body. In this way the guide may be dimensioned relative to the size of the panel interstices so that body parts are required to flex towards one another to be received in the interstices of the panels and thereby engage the boundary structure of those interstices by an interference fit. This allows the guide to induce a biasing force on the panels to cause them to align.

According to a second embodiment, there is provided a method of aligning more than one mesh interstices comprising the steps of locating a first mesh panel having a first mesh interstice to a structure; securing a guide to the first mesh panel; and securing a second mesh panel to the guide so as to cause the first and second mesh interstice to substantially align with one another.

### BRIEF DESCRIPTION OF THE FIGURES

Various embodiments, incorporating all aspects of the invention, will now be described by way of example only and with reference to the accompanying drawings,.

FIG. 1 shows an elevation view of one embodiment in accordance with the present disclosure.

FIG. 2 shows a prospective view of the embodiment shown in FIG. 1.

FIG. 3 shows the embodiments shown in FIGS. 1 and 2 used to align one interstice of two respective overlapping mesh panels.

FIG. 4 shows an elevation view of a further embodiment.

### DETAILED DESCRIPTION

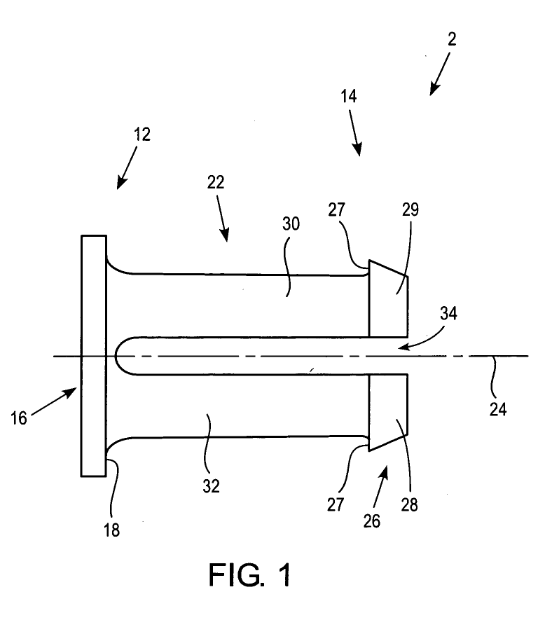

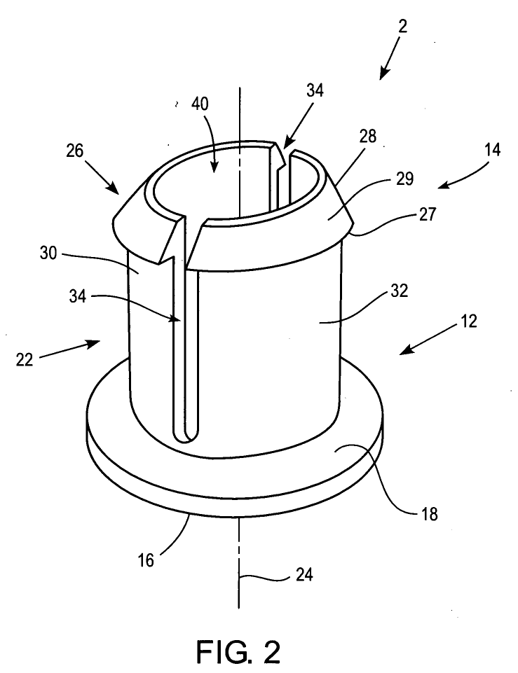

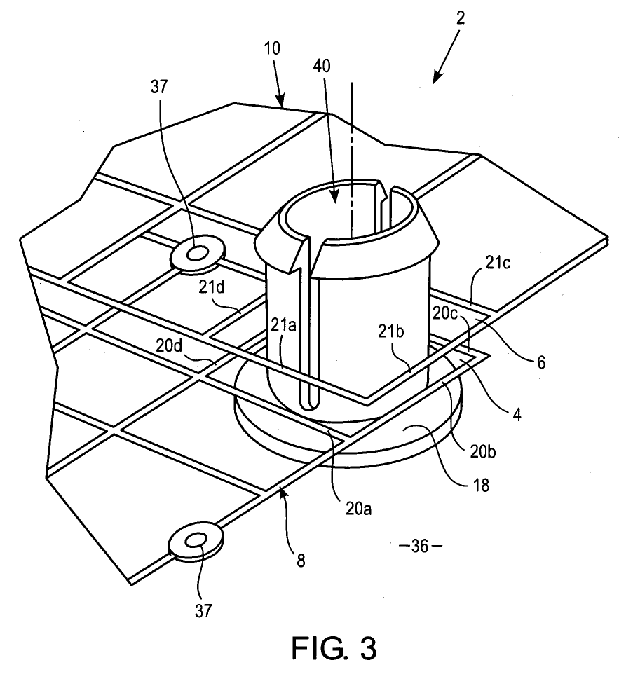

With reference to FIGS. 1 through 3, there is shown one embodiment of a guide 2 for aligning mesh interstices 4,6 of a first mesh panel 8 and a further mesh panel 10 respectively (shown in FIG. 3).

In the illustrated embodiment, the guide 2 comprises a base 16, a body 22 that extends from the base and head portion 26 located at a terminal end of the body and being enlarged relative to the body 22.

The base 16 comprises a first flange portion 18 formed of an appropriate dimension for engaging with the bounding structure 20 of the mesh interstice 4 of the mesh panel 8. For the embodiment shown, the peripheral shape of the base 16 is generally circular. However, it will be appreciated that the base 16 may be formed of any shape.

The body 22 extends away from the base 16 in a direction substantially aligned, and concentric with, longitudinal axis 24 of the guide 2. The guide 2 includes a first portion 12 comprising the inner surface of the base 16 and adjacent part of the body 22 that is configured for engaging the first mesh panel 8 and a second portion 14 comprising a distally adjacent part of the body 22 and head portion 26 configured for engaging the further mesh panel 10. When the first and second portions 12 and 14 are engaged, the mesh interstices 4, 6 of respective first 8 and further mesh panels 10 are caused to be substantially aligned. In the illustrated form, the body 22 is generally cylindrical but may be formed of any geometric shape that is sufficiently dimensioned so as to fit within an interstice of a given mesh panel. For example, guide 2 may be produced having differently sized body portions depending upon a specific mesh interstice size of a given mesh panel. For the embodiment shown, the dimension of the body 22 is smaller than the outer or peripheral dimension of the base 16. Further embodiments of the body 22 may differ in dimension relative to the base 16 pending the use of other means of fasteners used to secure the guide 2 to the mesh interstice 4 of the mesh panel 8 prior to engagement with a further mesh panel 10.

For the current embodiment, the body 22 is formed integral with the base 16, however, it may be appreciated that both the base and the body may comprise separate components and are assembled to one another by any fastening means known in the art, such as for example, nut and bolt arrangements or suitable welding methodologies.

The head portion 26 disposed at the terminal end of the guide opposite the base and incorporates a lip 27. As with the shape of both the base 16 and the body 22, the peripheral shape of the head portion 26 is generally circular. For the embodiment shown, the outermost dimension of the lip 27 is larger than the dimension of the body 22 so as to provide a capture point for retaining mesh interstices when positioned about the body 22.

The head portion 26 includes a chamfered portion 28 having an outwardly facing surface 29 sloping substantially inwards from the lip 27 towards the terminal end of the second portion 14. For the embodiment of the guide 2 shown, the chamfered portion 28 assists with placement of the second portion 14 within a mesh interstice of a mesh panel whereby the sloping surface allows the, for example, bounding structure 21 of mesh interstice 6 of mesh panel 10 to ‘ride’ over the head portion 26 and become positioned about the body 22. The dimension of the chamfered portion 28 may vary so as to be commensurate with the dimension of the mesh interstice geometry and the nature of the ‘fit’ required between the body 22 and the mesh interstice.

For the current embodiment of the guide 2, the body 22 is formed with a first part 30 and a second part 32 separated by an axial slit 34. The axial slit 34 extends from the distal end of the body and dimensioned so both first 30 and second 32 parts are able to resiliently flex towards each other to reduce the cross-sectional area of the body 22 thus reducing the effective stiffness of the body.

The guide 2, as illustrated, is hollow and includes an axial extending cavity 40 that extends from the terminal end to the base 16. The incorporation of the cavity 40 causes the first and second parts 30 and 32 to be relatively thinned walled structures and may be of any dimension sufficient to provide the requisite strength and stiffness characteristics required for aligning and retaining the required mesh panels.

For the current embodiment, the guide 2 is formed from polypropylene. However, the guide 2 may be formed from any material having suitable strength and weight characteristics sufficient for use with the weight and size of the intended mesh panels. In further embodiments, the guide 2 may be formed from materials suitable for use with injection moulding and like forming processes.

With reference to FIG. 3, installation of the guide 2 may be performed by first installing the first mesh panel 8 to a structure, such as for example, the surface 36 of a mining tunnel. The first mesh panel 8 may be affixed to the ceiling using, for example, rock bolts 37 with washer or butterflies so as to clamp the mesh in position.

The guide 2 is placed in position within the interstice 4 of the mesh panel 8 so that the base 16 is placed substantially adjacent surface 36 whereby the flange portion 18 engages the bounding structure 20 of the mesh interstice 4. Alternatively, the guide 2 may be secured to the mesh panel 8 using other fastening means, such as for example, cable ties or nut and bolt arrangements to bolt the flange directly to respective portions of the bounding mesh structure 20 of the mesh interstice 4.

A further mesh panel 10 is then positioned relative the mesh panel 8 in an overlapping arrangement whereby mesh interstice 6 of mesh panel 10 is placed over the second portion 14 so as to be positioned about the body 22 and effectively retained by the guide 2. Placement of the mesh interstice 6 may be achieved, in one embodiment, by deforming the body 22 by closing up the axial slit 34 and bringing both first 30 and second 32 parts together. Once the mesh interstice 6 is positioned around the body 22, the first 30 and second 32 parts are released and the body 22 adopts its initial position. Depending upon the relative geometries, release of the first 30 and second 32 parts may provide for an interference fit between the body 22 and the interstice 6. The bounding structure 21 of the mesh interstice 6 is retained about the body 22 due to the dimension of the flange portion 26 being larger than the body 22.

Once the mesh interstice 6 has been positioned about the body 22 of the guide 2, both mesh interstices 4, 6 will be aligned relative one another providing a clear and unimpeded passage for a rock bolt or like fastener to secure or clamp the mesh panels together to the surface 36. It is to be appreciated that the guide 2 may be designed to align more than two mesh panels by varying the length of the body 22.

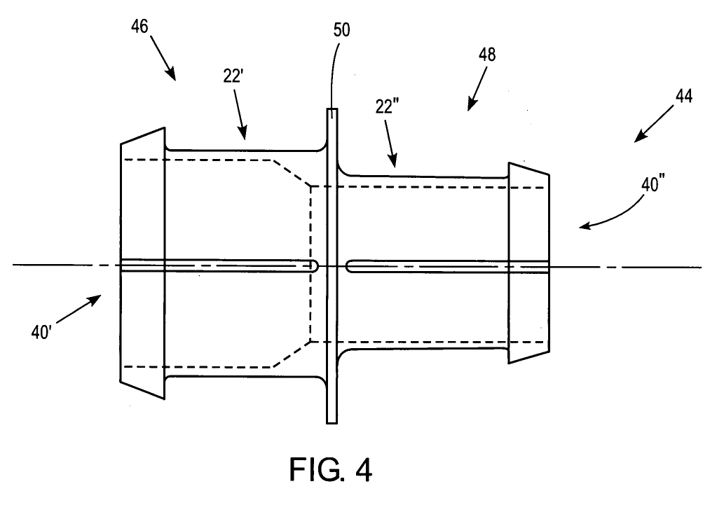

A further embodiment is shown in FIG. 4 whereby a guide 44 is presented. In the embodiment shown, the guide 44 comprises a first guide portion 46 and a second guide portion 48. The first and second guide portions 46, 48 are each structured substantially as the guide 2 (incorporating a base, body and head portion) as previously described. However in the embodiment of FIG. 4, the portions 46, 48 share a common base 50 and extend outwardly from that base in opposite directions. For the embodiment shown, the second guide portion 48 comprises a body portion 22″ that is smaller in dimension to the body portion 22′ of the first guide portion 46. It will be appreciated that the relative dimensions between corresponding features of the first 46 and second 48 guide portions may vary depending upon the geometry of the mesh interstices of the mesh panels that the guide 44 is to be used with, i.e., the first guide portion 46 may be intended to fit within a different size mesh interstice than that intended for the second guide portion 48. As such, the guide 44 is able to align and retain mesh interstices of different sizes. Further, the respective body portions can be increased or decreased in length depending upon the number of mesh panels that are intended to be retained on each respective body portion 22′, 22″.

The first and second guide portions 46, 48 are hollow and include respective axial extending cavities 40′ and 40″ that are in communication with one another. However, it may be appreciated that in other embodiments the cavities 40′, 40″ may not be in communication with each other.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Although described in connection with preferred embodiments thereof, it will be appreciated by those skilled in the art that additions, deletions, modifications, and substitutions not specifically described may be made without departure from the spirit and scope of the invention as defined in the appended claims.

What is claimed is:

1. A guide for aligning at least one mesh interstice of more than one respective mesh panel, the guide comprising:
a first portion configured for engaging the first mesh panel; and
a second portion configured for engaging a further mesh panel,
wherein, when the first and second portions are so engaged, the at least one mesh interstice of the respective first and further mesh panels are caused to substantially align.

2. A guide according to claim 1, wherein at least one of the first and second portions of the guide is configured for placement within the at least one mesh interstice of the mesh panel in which that portion engages.

3. A guide according to claim 2, wherein the guide includes a base and at least one generally cylindrical body, wherein the first and second portions are formed as sections on the body, or if the guide includes more than one body, as sections on respective ones of the bodies.

4. A guide according to claim 3, wherein at least one of the bodies further comprises first and second parts that are separated by an axial slit extending from a distal end of the body, the parts being able to resiliently flex towards one another so as to reduce the cross-sectional area of the body.

5. A method of aligning more than one mesh interstices comprising the steps of:
locating a first mesh panel having a first mesh interstice to a structure;
securing a guide to the first mesh panel; and
securing a second mesh panel to the guide so as to cause the first and second mesh interstices to substantially align with one another.
